(19) United States
(12) Patent Application Publication
(10) Pub. No.: US 2024/0082779 A1
(43) Pub. Date: Mar. 14, 2024

(54) CLEAN WATER RECIRCULATION FOR STEAM PRODUCTION IN ROTATING PACKED BED DESORBER SYSTEM

(71) Applicant: GTI ENERGY, DES PLAINES, IL (US)

(72) Inventors: Travis PYRZYNSKI, Rockford, IL (US); Guillermo CHAQUINGA NAVARRO, Doral, FL (US); Sanad SAWAKED, Hoffman Estates, IL (US); Osman AKPOLAT, Northbrook, IL (US)

(73) Assignee: GTI ENERGY, DES PLAINES, IL (US)

(21) Appl. No.: 18/244,673

(22) Filed: Sep. 11, 2023

Related U.S. Application Data
(60) Provisional application No. 63/405,186, filed on Sep. 9, 2022.

(51) Int. Cl. B01D 53/14

(52) U.S. Cl. CPC B01D 53/1431; B01D 53/1425; B01D 2257/504; B01D 2259/40088; B01D 2259/401

(57) ABSTRACT

A system and method for optimizing operation of a rotating packed bed desorber or regenerator wherein a rich solvent is input and CO2 product and lean solvent are output includes collecting condensed water from a regeneration section of a rotating packed bed desorber system. The collected condensed water is then repressurized and reheated to generate steam and the steam is injected into the rotating packed bed desorber or regenerator as stripping vapors while heating rich solvent.

### CROSS REFERENCE TO RELATED APPLICATION

This application claims the benefit of U.S. Provisional Patent Application Ser. No. 63/405,186, filed on 9 Sep. 2022. The co-pending provisional application is hereby incorporated by reference herein in its entirety and is made a part hereof, including but not limited to those portions which specifically appear hereinafter.

### STATEMENT REGARDING FEDERALLY SPONSORED RESEARCH OR DEVELOPMENT

This invention was made with government support under grant DE-FE0031630 awarded by DOE. The government has certain rights in the invention.

### BACKGROUND OF THE INVENTION

### Field of the Invention

This invention relates to a system and method for steam production and recirculation in a rotating bed desorber and/or regenerator system.

### Description of Related Art

ROTA-CAP is a carbon capture technology developed by GTI Energy using rotating packed bed (RPB) absorbers and regenerators in an integrated, process-intensified carbon capture system using advanced solvents.

The RPB is used in combination with an advanced solvent technology in an effort to reduce the capital and operating expenditure of carbon capture systems to meet or exceed cost targets for carbon capture from low percentage CO2 sources, such as pulverized coal (PC)-fired power plant flue gas or natural gas-derived flue gas and/or other industrial sources. These targets are for a new coal-fired power plant with CO2 capture to achieve ≥90% of the CO2 from the flue gas. The product CO2 is to have a purity of ≥95% and a cost of electricity at least 30% lower than that of a supercritical PC with CO2 capture or approximately $30 per ton of CO2 by 2030.

The rotation applied to the solvent by the RPBs, allows the system to use higher solvent concentrations compared to traditional absorbers. The higher solvent concentration allows for a higher concentration (loading) of CO2 per overall liquid volume compared to a traditional system.

Traditionally, vapors from a reboiler are used in a stripping section to remove the CO2 from the rich solvent. The current system, developed by GTI Energy, utilizes the vapors from the two-phase separator to strip the rich solvent in the rotating packed bed regenerator, without any reheating of the vapors. The regeneration performance is limited by the temperature of the stripping vapors and the amount of CO2 present in the cooler stripping vapors provided by the two-phase separator. This leads to a decreased performance of the overall system due to the poor CO2 removal in the regeneration section.

A need therefore exists for a system and method that permits efficient recirculation of steam at optimal temperatures to remove CO2 in the RPB regenerator without a worry of excess solvent degradation.

### SUMMARY OF THE INVENTION

The subject invention allows the system to be run at higher solvent concentrations. This thereby increases the amount of CO2 captured in the solvent and the partial pressure of the CO2 in the regeneration section. To optimize the CO2 stripping in the rotating packed bed regenerator, the condensed water from the CO2 product lines is repressurized, reheated, to generate clean stripping vapors, and sent to the rotating packed bed regenerator.

The subject invention is directed to a method and apparatus that requires condensed water from a regeneration section of a rotating packed bed system to be collected, repressurized and then reheated to generate steam. The generated steam is then used as stripping vapors in the rotating packed bed regenerator while heating the rich solvent. This operation may decrease the vapor pressure of CO2 to regenerate the rich solvent.

The repressurization, prior to reheating, of the condensed water will help the process by controlling the pressure of the water and avoid reverse flow from the rotating packed bed regenerator to the condensed water section. The reheating of the condensed water will help the process by controlling the temperature of the steam and sending this steam, to the rotating packed bed regenerator.

Other objects and advantages will be apparent to those skilled in the art from the following detailed description taken in conjunction with the appended claims and drawings.

### BRIEF DESCRIPTION OF THE DRAWINGS

FIG. 1 shows a rotating packed bed absorber or regenerator according to the prior art;

FIG. 2 shows a schematic of a process flow according to the prior art; and

FIG. 3 shows a schematic of a process flow of the subject system according to one embodiment.

### DETAILED DESCRIPTION OF THE INVENTION

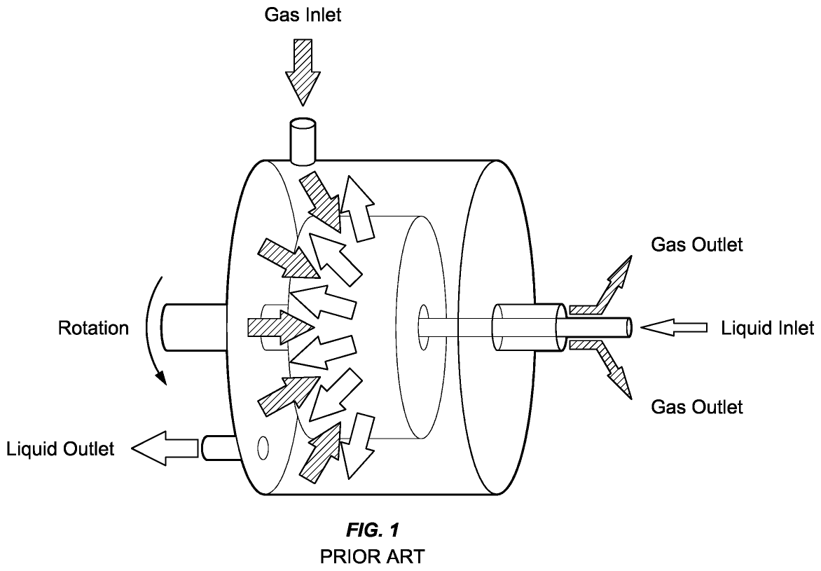

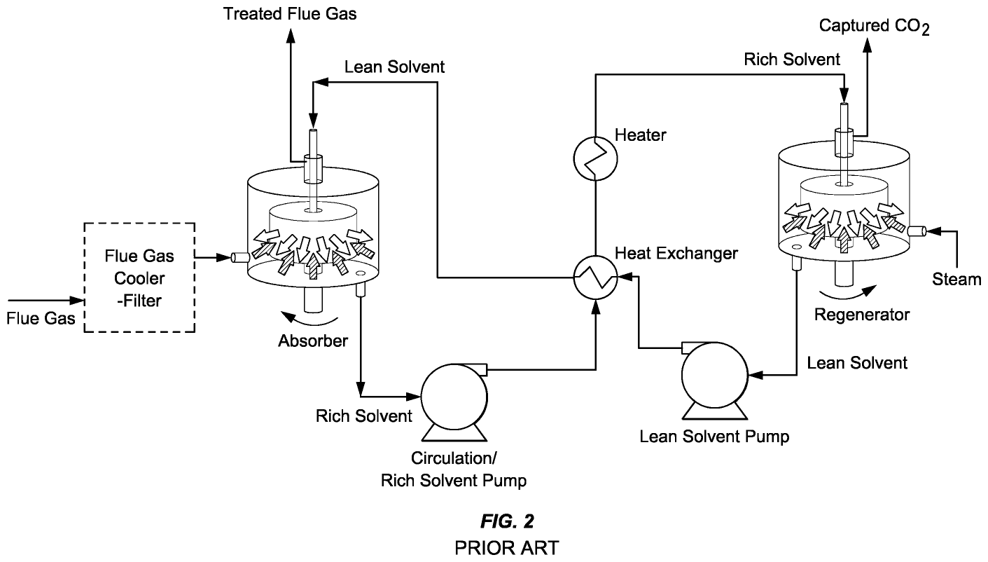

FIG. 1 shows a schematic of a basic prior art packed bed absorber. FIG. 2 shows a schematic of a process flow of a prior art system utilizing packed bed absorbers and regenerators in an integrated, process-intensified carbon capture system using advanced solvents. In embodiments of the subject invention, a single or multi-stage packed bed absorber contacts a gas with a solvent to absorb one or more gas components to the liquid. The liquid is pressurized and circulated to an energy efficient solvent regeneration process, such as described in U.S. Pat. No. 9,901,846, herein incorporated by reference, where the solvent is regenerated. The resulting solvent is circulated back to the rotating packed bed for further use and absorption. The invention can be incorporated with one or more rotating packed bed absorbers, desorbers and/or regenerators.

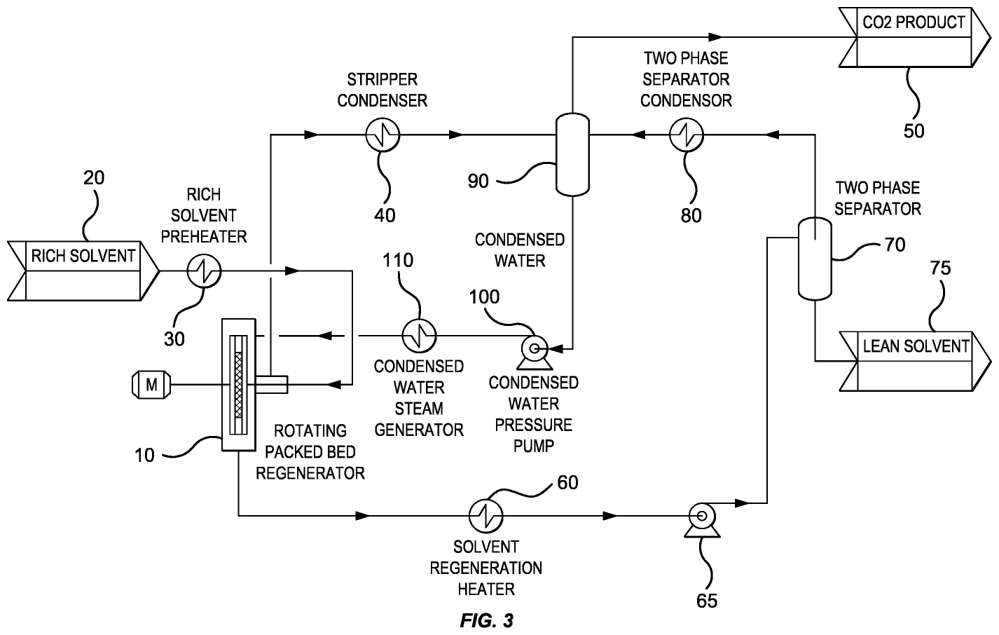

FIG. 3 shows a schematic of a process flow of the subject system for steam production and recirculation in a rotating bed desorber system. As shown in the schematic, a rich solvent is input to the system resulting in a CO2 product output together with a lean solvent.

FIG. 3 shows the subject system includes a rotating packed bed desorber or regenerator 10 and a rich solvent inlet 20. The rich solvent is preferably preheated in a preheater 30 prior to introduction to the rotating packed bed regenerator 10. The rich solvent can be loaded with CO2 up to 11 wt % and preferably within a range of 8-11 wt % prior to injection to the regenerator. The regenerator will operate with target temperatures to vaporize the water and CO2 from the solvent, 230F to 280F. The regenerator can produce lean solvent loaded with CO2 from ranges 2-5 wt %.

The subject invention is directed to a method and apparatus that requires condensed water from a regeneration section of a rotating packed bed system to be collected, repressurized and then reheated to generate steam. The generated steam is then used as stripping vapors in the rotating packed bed regenerator while heating the rich solvent. This operation may decrease the vapor pressure of CO2 to regenerate the rich solvent and aids in maintaining the regenerator 10 temperature.

The repressurization of the condensed water, prior to reheating, aids in the process by controlling the pressure of the water and avoiding reversed flow from the rotating packed bed regenerator 10 to the condensed water section. The reheating of the condensed water aids in the process by controlling the temperature of the steam and sending this steam, to the rotating packed bed regenerator 10.

The rotating packed bed regenerator 10 thereafter provides a flow of lean solvent, with a L/G, where the gas flow rate used is from the inlet flue gas to the absorber, ranging from 0.5 to 20.0, with gas and liquid in both Nm3/hr, and captured CO2 product to a stripper condenser 40 which provides condensed water and CO2 into a two phase separator vessel 90, referred to as a “knockout separator 90” hereafter, which holds a supply of condensed water, with an operating pressure of 1-10 psig and removes captured CO2 product to an outlet 50 of the system. In addition, a further output flow of the lean solvent is provided to a solvent regeneration heater 60 and preferably through a pump 65 where it is introduced to a two phase separator 70, operating a few psig less than the regenerator 10, that provides an output 75 of lean solvent and a further aqueous stream to a two phase separator condenser 80 which provides water to the two phase separator vessel 90 and CO2 product to the outlet 50 of the system.

The knockout separator 90 preferably provides a source of condensed water, and may include trace amounts of volatile solvent compounds, to a condensed water pressure pump 100 for pressurizing the condensed water stream and a condensed water steam generator 110 for heating the pressurized condensed water stream. This pressurized and heated steam is then reintroduced to the rotating packed bed regenerator 10.

The subject invention thereby allows the system to be run at higher solvent concentrations. Higher solvent concentrations increase the amount of CO2 captured in the solvent and the partial pressure of the CO2 in the regeneration section. To optimize the CO2 stripping in the rotating packed bed regenerator, the condensed water from the CO2 product lines is repressurized and reheated using, for example, the pressure pump 100 and the steam generator 110 to generate clean stripping vapors. The resulting repressurized and reheated steam is then sent to the rotating packed bed regenerator 10. As shown and described the repressurizing of the condensed water preferably occurs prior to the reheating of the condensed water.

The subject method and system preferably operates at a pressure for the steam injection into the rotating packed bed desorber or regenerator 10 of between 10-100 psig. The subject method preferably operates at a temperature above a saturation temperature while avoiding excess degradation in the solvent.

As shown in FIG. 3, the subject method preferably includes separating CO2 product from lean solvent in two output streams, one from the two phase separator 70 and one from the knockout separator 90. As such, two or more separators 70, 90 are preferably included in the subject system and method to separate CO2 product from the lean solvent.

In addition, separate output streams are preferably connected from the rotating packed bed desorber or generator 10—one to a solvent regeneration heater 60 and one to a stripper condenser 40.

The subject system for optimizing operation of a rotating packed bed desorber or regenerator 10 shown in FIG. 3 includes a rich solvent 20 input and CO2 product output 50 and lean solvent output 75. The knockout separator 90 preferably collects condensed water from a regeneration section of the rotating packed bed desorber or regenerator 10 and provides a stream of condensed water toward the rotating packed bed desorber or regenerator 10. The knockout separator 90 also provides the CO2 product output from the subject system.

A pressure pump 100 is located downstream of the knockout separator 90 and is configured to repressurize collected condensed water. A steam generator 110 is positioned downstream of the pressure pump 100 and is configured to reheat the collected condensed water to generate steam. The generated steam is thus injected to the rotating packed bed desorber or regenerator 10 as stripping vapors while heating the rich solvent.

As shown, the subject system may further include a preheater 30 configured to heat the rich solvent prior to injection into the rotating packed bed desorber or regenerator. As described, the subject system preferably incorporates two or more separators 70, 90 for separating lean solvent from CO2 product and/or from water. One separator 70 is preferably positioned downstream of the rotating packed bed desorber or regenerator 10 and is configured to separate CO2 product from lean solvent and/or water into two output streams.

As shown in FIG. 3, and described above, the rotating packed bed desorber or regenerator 10 preferably includes at least two output streams. One output stream from the rotating packed bed desorber or regenerator 10 is preferably connected with respect to a solvent regeneration heater 60. At least one other output stream from the rotating packed bed desorber or regenerator 10 is preferably connected with respect to a stripper condenser 40.

While in the foregoing detailed description the subject development has been described in relation to certain preferred embodiments thereof, and many details have been set forth for purposes of illustration, it will be apparent to those skilled in the art that the subject development is susceptible to additional embodiments and that certain of the details described herein can be varied considerably without departing from the basic principles of the invention.

We claim:

1. A method for optimizing operation of a rotating packed bed desorber or regenerator system wherein a rich solvent is input and CO2 product and lean solvent are output, the method comprising:
collecting condensed water from a regeneration section of a rotating packed bed desorber system;
repressurizing the collected condensed water;
reheating the collected condensed water to generate steam; and
injecting the generated steam to the rotating packed bed desorber or regenerator as stripping vapors while heating the rich solvent.

2. The method of claim 1 further comprising operating at a pressure for the steam injection between 10-100 psig.

3. The method of claim 1 further comprising operating at a temperature above a saturation temperature while avoiding excess degradation in the solvent.

4. The method of claim 1 further comprising:
separating CO2 product from lean solvent in two output streams.

5. The method of claim 4 further comprising:
using two or more separators to separate CO2 product from the rich solvent.

6. The method of claim 1 wherein the condensed water from the regeneration section is collected in a knockout separator.

7. The method of claim 1 wherein the repressurizing of the condensed water occurs prior to the reheating of the condensed water.

8. The method of claim 1 further comprising:
providing separate output streams from the rotating packed bed desorber to a solvent regeneration heater and a stripper condenser, respectively.

9. The method of claim 1 wherein the condensed water is collected at an operating pressure of 1-10 psig.

10. The method of claim 1 wherein the rich solvent is loaded with CO2 up to 11 wt %.

11. A system for optimizing operation of a rotating packed bed desorber or regenerator wherein a rich solvent is input and CO2 product and lean solvent are output, the system comprising:
a knockout separator collecting condensed water from a regeneration section of the rotating packed bed desorber or regenerator;
a pressure pump configured to repressurize collected condensed water;
a steam generator positioned downstream of the pressure pump, the steam generator configured to reheat the collected condensed water to generate steam; and
an injector configured to inject the generated steam to the rotating packed bed desorber or regenerator as stripping vapors while heating the rich solvent.

12. The system of claim 11 further comprising:
a preheater configured to heat the rich solvent prior to injection into the rotating packed bed desorber or regenerator.

13. The system of claim 11 further comprising:
at least one additional separator positioned downstream of the rotating packed bed desorber or regenerator configured to separate CO2 product from lean solvent in two output streams.

14. The system of claim 11 further comprising:
an output stream from the rotating packed bed desorber or regenerator connected with respect to a solvent regeneration heater.

15. The system of claim 11 further comprising:
an output stream from the rotating packed bed desorber or regenerator connected with respect to a stripper condenser.

16. The system of claim 11 further comprising a stripper condenser and a two phase separator condenser each providing a separate streams of CO2 product and lean solvent to the knockout separator.
